(19) United States
(12) Patent Application Publication
(10) Pub. No.: US 2014/0095479 A1
(43) Pub. Date: Apr. 3, 2014

(54) DEVICE, METHOD, AND SYSTEM FOR RECIPE RECOMMENDATION AND RECIPE INGREDIENT MANAGEMENT

(71) Applicants: Sherry S. Chang, El Dorado Hills, CA (US); Charles Baron, Chandler, AZ (US); Oliver W. Chen, Folsom, CA (US)

(72) Inventors: Sherry S. Chang, El Dorado Hills, CA (US); Charles Baron, Chandler, AZ (US); Oliver W. Chen, Folsom, CA (US)

(21) Appl. No.: 13/631,531

(22) Filed: Sep. 28, 2012

(51) Int. Cl. G06F 17/30

(52) U.S. Cl. 707/722; 707/E17.005

(57) ABSTRACT

A method, device, and system for generating a list of recipe recommendations includes determining the type and quantity of ingredients available to a user of a mobile computing device or smart storage. The available ingredients may be determined using text input or voice input from the user. A camera may also be used to capture images of the available ingredients for analysis. The list of recipes may be generated as a function of the type and quantity of available ingredient(s), meal preferences of the user, and the context of the meal. Recipe complements and/or supplements may be suggested in response to the user selecting a recipe from the list of recipe recommendations. Further, a meal planner may be used to track the shelf life of the ingredient(s), plan a meal schedule, and generate a shopping list

### BACKGROUND

For many households in today's fast-paced society, the decision of what to make for dinner is much more routine than in years past. The ‘chef’ of many families is oftentimes whomever is willing to cook. Having limited cooking experience or lack of a desire to plan out a meal with a cookbook, the family chef may simply resort to the ready-made frozen food aisle at the grocery store or retrieve food from the neighborhood take-out establishment. Further, those meals that the family chef does make homemade are typically made over and over again, sometimes so frequently that a day of the week is named after the meal (e.g., meatloaf night).

Mobile communication devices are becoming ubiquitous tools for personal, business, and social uses. While the primary use for many mobile communication devices remains person-to-person communication via voice or textual technologies, modern mobile communication devices are equipped with increased processing power and data storage capability to allow such devices to perform advanced processing. For example, many modern communication devices, such as typical “smart phones,” are capable of executing specialized operating systems and associated software applications. Additionally, many modern mobile communication devices are capable of connecting to various data networks, including the Internet, to retrieve and receive data communications over such networks.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for generating a list of recipe recommendations;

FIG. 2 is a simplified block diagram of at least one embodiment of an environment of a mobile computing device of the system of FIG. 1;

FIG. 3 is a simplified block diagram of at least one embodiment of a smart storage of the system of FIG. 1;

FIG. 4 is a simplified flow diagram of at least one embodiment of a method for generating a list of recipe recommendations and a meal schedule on the mobile computing device of FIG. 1;

FIG. 5 is a simplified flow diagram of at least one embodiment of a method for determining available ingredients on the mobile computing device of FIG. 1;

FIG. 6 is a simplified flow diagram of at least one embodiment of a method for determining available ingredients using an image generated by a camera of the mobile computing device of FIG. 1;

FIG. 7 is a simplified diagram of at least one embodiment of a screen capture generated with the mobile computing device of FIG. 1;

FIG. 8 is a simplified flow diagram of at least one embodiment of a method for generating recommended recipes on the mobile computing device of FIG. 1; and

FIG. 9 is a simplified flow diagram of at least one embodiment of a method for generating a meal schedule on the mobile computing device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

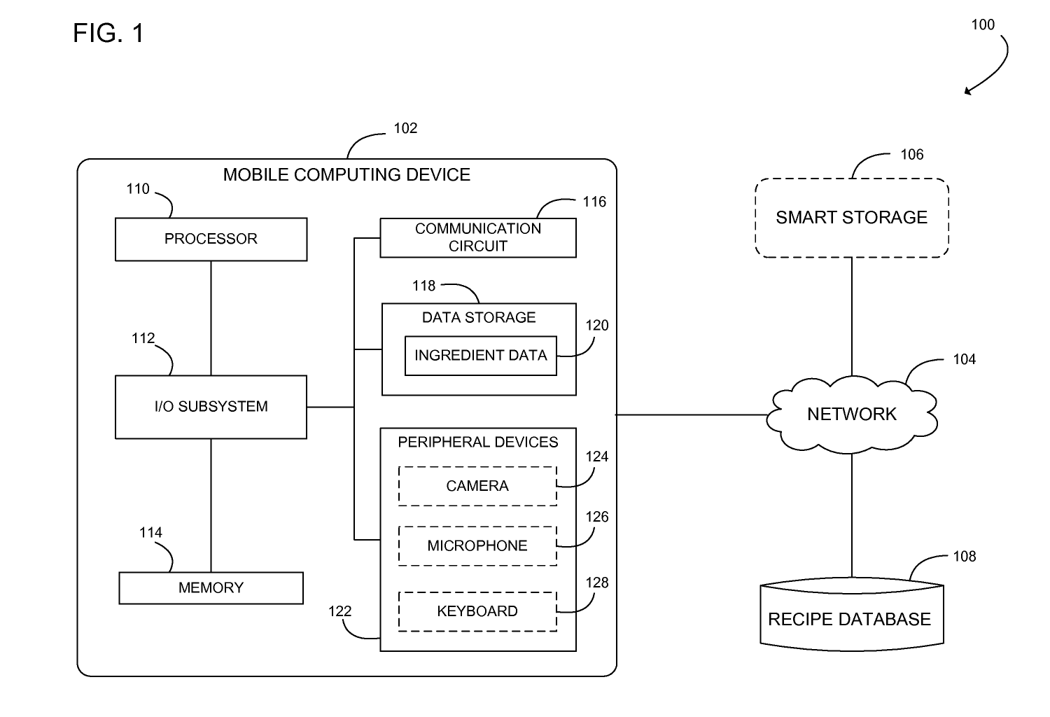

Referring now to FIG. 1, an illustrative system 100 for generating a list of recipe recommendations includes a mobile computing device 102, a network 104, and a recipe database 108. In use, as discussed in more detail below, the mobile computing device 102 may communicate with the recipe database 108 over the network 104 to search for recipes to recommend to a user of the mobile computing device 102 based on the user's ingredients on-hand. Some embodiments may include a smart storage 106, which may similarly communicate with the recipe database 108 over the network 104 to retrieve recipe information based on the available ingredients. Although only one mobile computing device 102, one network 104, one smart storage 106, and one recipe database 108 are illustratively shown in FIG. 1, the system 100 may include any number of mobile computing devices 102, networks 104, smart storages 106, and recipe databases 108 in other embodiments.

The mobile computing device 102 may be embodied as any type of computing device for generating a list of recipe recommendations and performing the function described herein such as a smart phone, tablet computer, cellular phone, personal digital assistant, and/or other computing device. Although the computing device 102 is a mobile device in the illustrative embodiment, in other embodiments, the mobile computing device 102 may be a predominantly stationary computing device such as a desktop computer. In the illustrative embodiment of FIG. 1, the mobile computing device 102 includes a processor 110, an I/O subsystem 112, a memory 114, a communication circuitry 116, a data storage 118, ingredient data 120, and one or more peripheral devices 122. Of course, the mobile computing device 102 may include other or additional components, such as those commonly found in a computing device (e.g., various input/output devices), in other embodiments. Additionally, in some embodiments, one or more of the illustrative components may be incorporated in, or otherwise from a portion of, another component. For example, the memory 114, or portions thereof, may be incorporated in the processor 110 in some embodiments.

The processor 110 may be embodied as any type of processor capable of performing the functions described herein. For example, the processor may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the mobile computing device 102 such as operating systems, applications, programs, libraries, and drivers. The memory 114 is communicatively coupled to the processor 110 via the I/O subsystem 112, which may be embodied as circuitry and/or components to facilitate input/output operations with the processor 110, the memory 114, and other components of the mobile computing device 102. For example, the I/O subsystem 112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 112 may form a portion of a system-on-a-chip (SoC) and be incorporated, along with the processor 110, the memory 114, and other components of the mobile computing device 102, on a single integrated circuit chip.

The communication circuit 116 of the mobile computing device 102 may be embodied as any communication circuit, device, or collection thereof, capable of enabling communications between the mobile computing device 102 and the recipe database 108 and/or other remote devices. The communication circuit 116 may be configured to use any one or more communication technology (e.g., wireless or wired communications) and associated protocols (e.g., Ethernet, Bluetooth®, Wi-Fi®, WiMAX, etc.) to effect such communication.

The data storage 118 may be embodied as any type of device or devices configured for short-term or long-term storage of data such as, for example, memory devices and circuits, memory cards, hard disk drives, solid-state drives, or other data storage devices. In the illustrative embodiment, the mobile computing device 102 may maintain ingredient data 120 and/or other information in the data storage 118. As discussed in more detail below, the ingredient data 120 may include the type and quantity of ingredient(s) available to the user (e.g., the ingredients the user current has on-hand). The ingredient data 120 may be stored for future meal planning and to monitor the shelf life of the ingredients for spoilage concerns.

The peripheral devices 122 of the mobile computing device 102 may include any number of peripheral or interface devices. For example, the peripheral devices 122 may include a display, a keyboard, a mouse, external speakers, and/or other peripheral devices. In some embodiments, the peripheral devices 122 may include a camera 124 to take pictures of the available ingredients. The camera 124 may be embodied as any peripheral device suitable for capturing images, such as a still camera, a video camera, or the like. Further, in some embodiments, the peripheral devices 122 may include a microphone 126 to capture audio of the user. That is, the user may dictate the type and/or quantity of available ingredients to the mobile computing device 102 via the microphone 126. The peripheral devices 122 may also include a keyboard 128, which may be used by the user to enter the type and/or quantity of ingredients on hand. The particular devices included in the peripheral devices 122 may depend on, for example, the intended use of the mobile computing device 102. The peripheral devices 122 are communicatively coupled to the I/O subsystem 112 via a number of signal paths thereby allowing the I/O subsystem 112 and/or processor 110 to receive inputs from and send outputs to the peripheral devices 122.

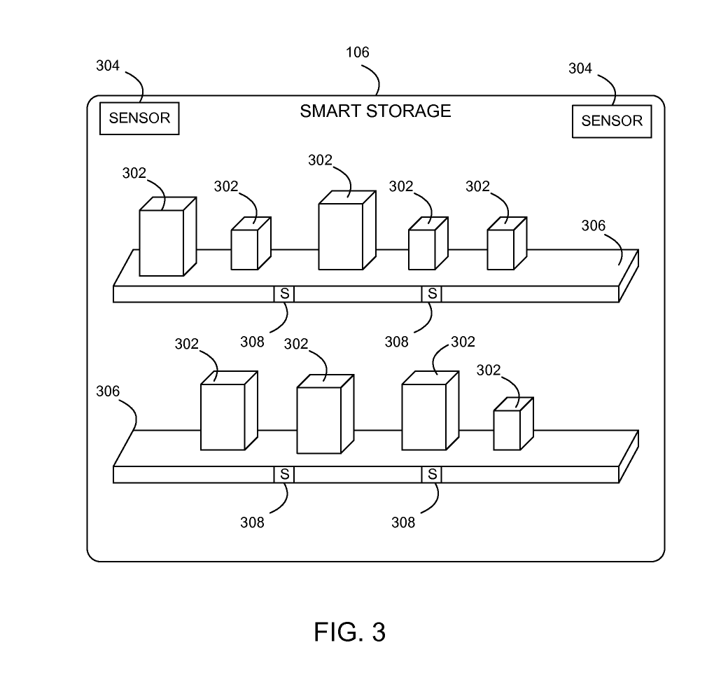

The smart storage 106, which is discussed in more detail below with regard to FIG. 3, may be embodied as any type of storage device or location for storing ingredients. For example, the smart storage 106 may be embodied as a smart refrigerator, smart pantry, smart cabinet, and/or other smart storage device. The smart storage 106 may have similar hardware, firmware, and/or software to the mobile computing device 102. For example, the smart storage 106 may include a processor, memory, I/O subsystem, communication circuit, data storage, and/or peripheral devices similar to those of the mobile computing device 102 discussed above. The description of those components of the mobile computing device 102 is equally applicable to the similar components of the smart storage 106 and is not repeated herein for clarity of the description. As such, the smart storage 106 may include any type of computing device, hardware, firmware, and/or software capable of performing the functions described herein. Furthermore, it should be appreciated that the smart storage 106 may include other components, sub-components, and devices commonly found in a computer and/or computing device, which are not illustrated in FIG. 1 for clarity of the description.

The recipe database 108 may be any electronic arrangement or structure suitable for storing data directed to culinary recipes. In one embodiment, access to the recipe database 108 is managed by a web service server, which the mobile computing device 102 may communicate with over the network 104. The network 104 may be embodied as any type of network capable of facilitating communication between the mobile computing device 102, the smart storage 106, and the recipe database 108. As such, the network 104 may include one or more networks, routers, switches, computers, and/or other intervening devices. In an illustrative embodiment, the network 104 is embodied as a publicly-available, global network such as the Internet.

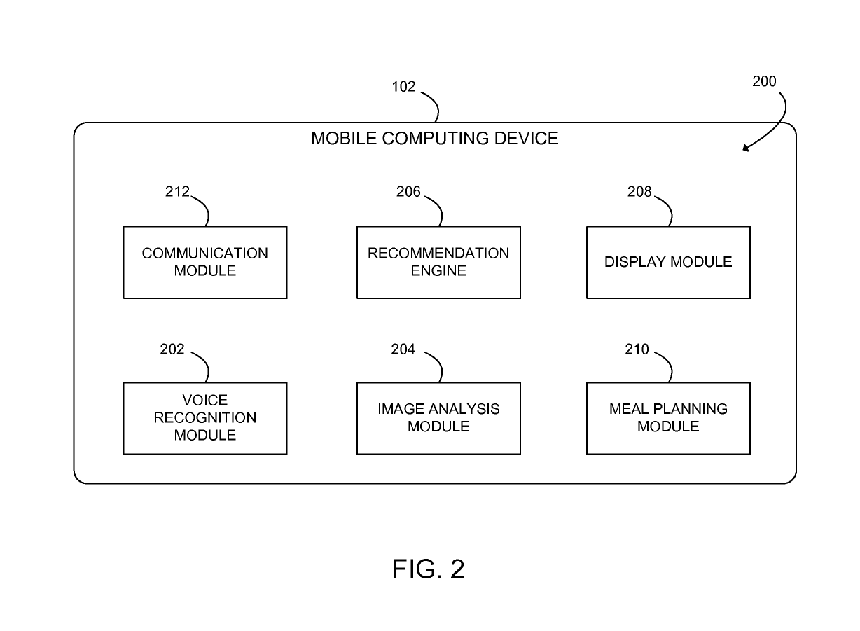

In use, as shown in FIG. 2, the mobile computing device 102 may establish an environment 200 for generating a list of recipe recommendations. The environment 200 in the illustrative embodiment includes a voice recognition module 202, an image analysis module 204, a recommendation engine 206, a display module 208, a meal planning module 210, and a communication module 212, each of which may be embodied as firmware, software, hardware, or a combination thereof.

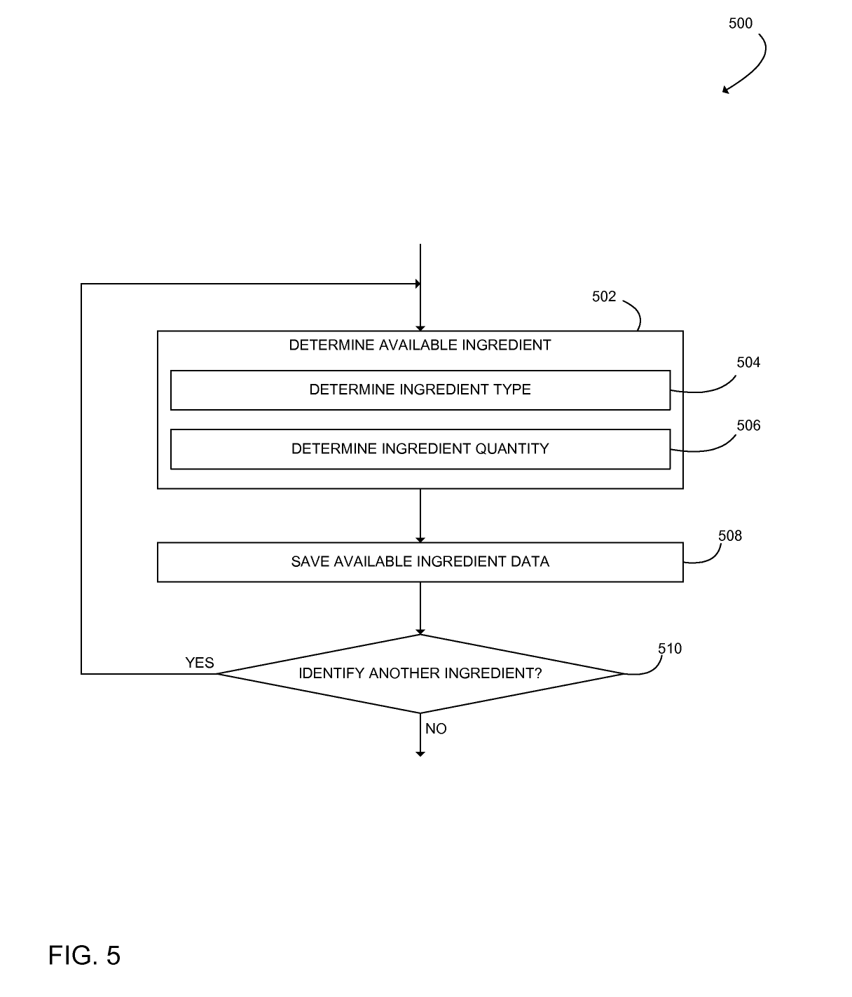

The voice recognition module 202 is configured to analyze audio input received via the microphone 126 of the mobile computing device 102. As discussed in more detail below (see block 502 of FIG. 5), the user of the mobile computing device 102 may dictate a type of ingredient available to the user and the corresponding quantity of that ingredient. For example, in some embodiments, the user may go through a pantry, refrigerator, or other food storage area and tell the mobile computing device 102 all of the available ingredients and the amount remaining in each corresponding package. For example, in some embodiments, the user may simply speak through the microphone, “We have half a gallon of milk, three carrots, and six ounces of cream cheese.” In other embodiments, the user may be guided through prompts to provide audio input. The voice recognition module 202 of the mobile computing device 102 may parse, interpret, and/or otherwise analyze the spoken audio to determine the type and quantity of available ingredients and store that information as the ingredient data 120.

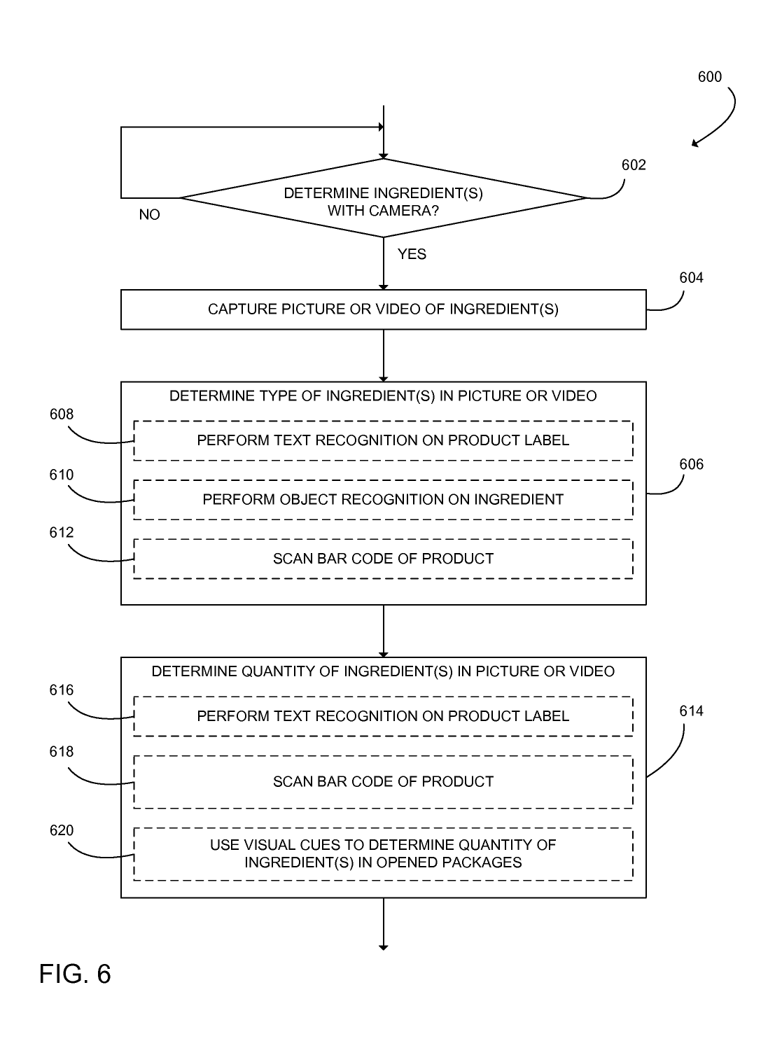

The image analysis module 204 is configured to analyze one or more images captured with the camera 124 of the mobile computing device 102. As discussed in more detail below in regard to method 600 of FIG. 6, the image analysis module 204 may automatically, or semi-automatically, determine the type and quantity of ingredients available by analyzing the captured images of the ingredients. For example, in some embodiments, the user may take a photograph of one or more ingredients available to the user (e.g., stored in a refrigerator or pantry) to be analyzed by the image analysis module 204. In other embodiments, the user may record a video of the ingredients available (e.g., by walking through a pantry) for analysis by the image analysis module 204. In such embodiments, the image analysis module 204 may analyze one or more frames of the captured video individually or collectively. The image analysis module 204 may use any image analysis technique suitable for determining the type and/or quantity of one or more available ingredients. In the illustrative embodiment, the image analysis module 204 may use object recognition and text recognition techniques, interpret bar codes, or otherwise use visual cues in analyzing the images. The image analysis module 204 may store the ingredient data 120 identifying the type and/or quantity of available ingredients in the data storage 118 of the mobile computing device 102. In some embodiments, it should be appreciated that the image analysis module 204 may be executed by a processor graphics circuitry, a digital signal processor, or another suitable processor.

The recommendation engine 206 is configured to generate a list of recipe recommendations as a function of the available ingredients. In some embodiments, the recommendation engine 206 may retrieve ingredient data 120 stored in the data storage 118 of the mobile computing device 102. As discussed above, in the illustrative embodiment, the ingredient data 120 is generated as a function of the captured inputs directed to the type and quantity of ingredients available on hand. In other embodiments, such as text input, the recommendation engine 206 may determine the type and quantity of one or more ingredients as a function of the input directly.

The display module 208 is configured to display the recommended recipes on a display of the mobile computing device 102 for the user to view. In some embodiments, the display module 208 may display the recommended recipes on a display remote to the mobile computing device 102. In some embodiments, the user may sort the recommended recipes and/or refine the search results. In such embodiments, the display module 208 may be used to effect the user's desired display modification.

In some embodiments, the environment 200 may include the meal planning module 210, which is configured to generate, update, and store a meal schedules (e.g., on a calendar or other user-friendly format). Additionally, the meal planning module 210 may use the ingredient data 120 to track the shelf life of the available ingredients. Further, the meal planning module 210 may identify needed ingredients for upcoming meals and generate a shopping list for the user.

The communication module 212 handle the communication between the mobile computing device 102 and remote computing devices through the network 104, such as the recipe database and/or the smart storage 106. It should be appreciated that the smart storage 106 may establish an environment similar to the environment 200 for generating a list or recipe recommendations, which is not duplicated in the drawings for clarity of the description.

Referring now to FIG. 3, an illustrative embodiment the smart storage 106 for generating a list of recipe recommendations includes one or more available ingredients 302 stored in the smart storage 106, one or more sensors 304, one or more shelves 306, and one or more weight sensors 308. Each of the sensors 304 may be embodied as any type of sensor suitable for identifying or determining the type and/or quantity of one or more of the available ingredients 302 (e.g., a camera, bar code reader, etc.). In some embodiments, the sensors 304 may embodied as, or otherwise include, air sensors that may be used to detect odors in the smart storage 106 to, for example, detect spoilage of food or other ingredients 302. Although only two sensors 304 are shown in the illustrative embodiment of FIG. 3, the smart storage 106 may include one or more sensors 304 in other embodiments.

In the illustrative embodiment of the smart storage 106 in FIG. 3, several available ingredients 302 are shown on the shelves 306. In some embodiments, the shelves 306 may include weight sensors 308 in addition to or in place of the sensors 304, which may be used in determining the quantity of the available ingredients 302. Although two weight sensors 308 are shown on each shelf 306, one or more weight sensors 308 may be included on, attached to, or embedded in each shelf 306. For example, in some embodiments, a shelf 306 may include an array of sensors arranged in a predetermined configuration for effectively measuring the weights of one or more available ingredients 302 on the shelf 306.

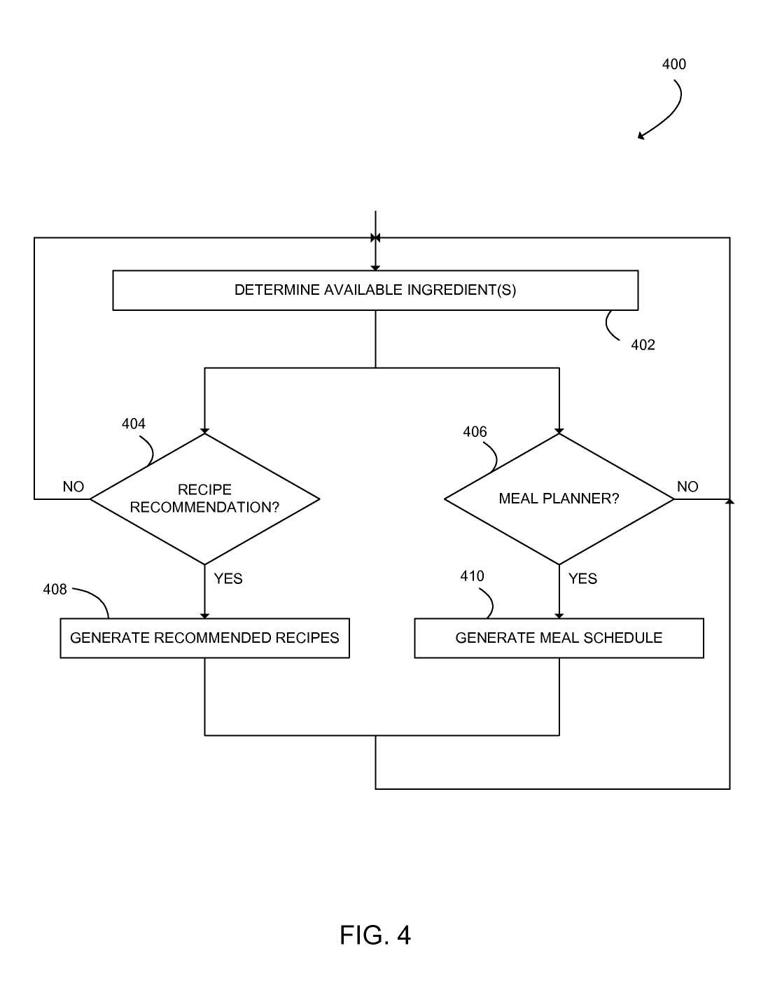

Referring now to FIG. 4, one illustrative embodiment of a method 400 for generating a list of recipe recommendations and a meal schedule, which may be executed by the mobile computing device 102, begins with block 402. In block 402, the mobile computing device 102 determines which ingredient(s) the user of the mobile computing device 102 has available. To do so, the mobile computing device 102 may execute a method 500 to determine the available ingredients as shown in FIG. 5. The method 500 begins with block 502 in which the mobile computing device 102 identifies or otherwise determines the available ingredient. In doing so, the mobile computing device 102 may determine the type of the available ingredient in block 504. For example, the mobile computing device 102 may determine ingredient type to be salt, milk, pancake mix, bread, or potatoes, among others. In some embodiments, the ingredient type may include the brand of the ingredient. In block 506, the mobile computing device 102 may determine the quantity of the available ingredient. The ingredient quantity may be determined using any suitable unit of measurement for the particular ingredient. The mobile computing device 102 may determine the ingredient type and quantity using any suitable method. For example, as discussed above, the user may enter the type and quantity of the available ingredient using the keyboard 128 of the mobile computing device 102 or dictate the type and quantity of the available ingredient using the microphone 126. In other embodiments, the camera 124 may be used to capture images of one or more ingredients for analysis. Additionally, it should be appreciated that the type and/or quantity of available ingredients may be determined using a combination of input methods and analyses.

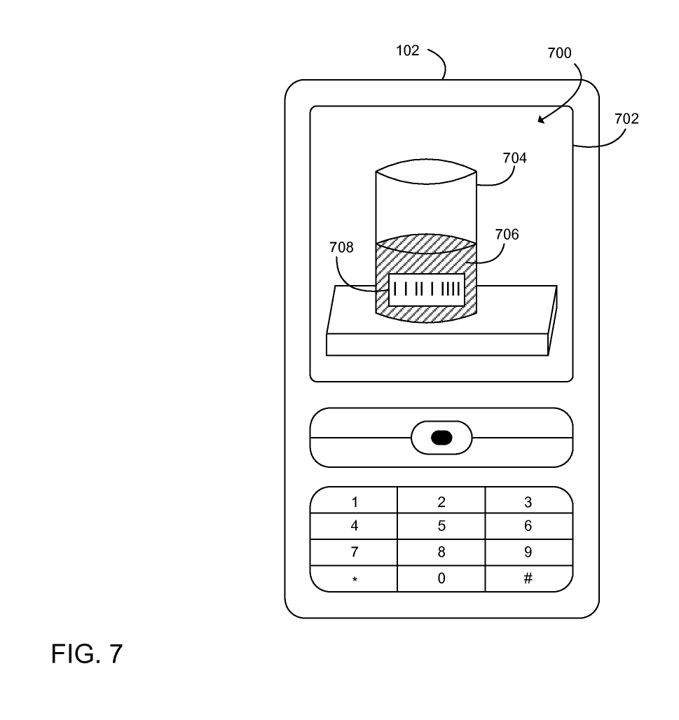

In embodiments in which the available ingredients are determined, in part or in whole, as a function of camera input, the mobile communication device may execute a method 600 as shown in FIG. 6. The method 600 begins with block 602 in which the mobile computing device 102 determines whether to use the camera 124 to determine the type and/or quantity of ingredients available to the user. For example, the user may respond to a prompt to input available ingredients by taking on or more pictures or recording a video of the ingredients. If the mobile computing device 102 determines that the camera 124 is to be used, the camera 124 captures an image or records a video of the available ingredients in block 604. As shown in FIG. 7, an illustrative embodiment of a screen capture 700 of the mobile computing device 102 shows the mobile computing device 102 capturing an image or video of an ingredient 704 on a shelf. In the illustrative embodiment, the packaging of the ingredient has been opened. Because the packaging is transparent or semi-transparent, the remaining quantity 706 of the ingredient is visible in the image. Additionally, the ingredient has a product label 708 on the packaging that can be seen in the image, which illustratively includes a bar code.

Referring back to FIG. 6, the mobile computing device 102 identifies or determines the type of the ingredients in the image(s) or video in block 606. As discussed above, the image analysis module 204 may use any image or video analysis technique suitable for identifying the ingredients 704. In doing so, in block 608, the image analysis module 204 may perform text recognition on the product labels 708 of the ingredients 704 shown in the image. Additionally or alternatively, in block 610, the image analysis module 204 may perform object recognition techniques on the image. For example, the image analysis module 204 may recognize the shape of a bag of potatoes. In block 612, the image analysis module 204 may interpret the bar code shown on a product label 708 to identify the ingredient 704. In doing so, the mobile computing device 102 may connect with a remote server through the network 104 to retrieve product information tied to the scanned or interpreted bar code. In some embodiments, the product information identifies both the type of the ingredient 704 and the quantity of the ingredient 704 in an unopened package.

In block 614, the mobile computing device 102 determines the quantity of the ingredients 704 in the image(s) or video. In some embodiments, the mobile computing device 102 determines the quantity of the ingredient 704 that may be stored in the package (i.e., the amount of the ingredient 704 in an unopened package). In other embodiments, the mobile computing device 102 determines the quantity of the ingredient 704 remaining in the package. Similar to block 608, in block 616, the image analysis module 204 may perform text recognition on the product label 708 of the ingredient to determine the quantity of the ingredient 704. In block 618, the image analysis module 204 may interpret or scan the bar code on the product label 708 to identify the quantity of the ingredient 704. As in block 612, the mobile computing device 102 may retrieve the quantity information from a remote server. In block 620, the image analysis module 204 may use visual cues to determine the quantity of ingredient 704 remaining in an opened package of the ingredient 704. For example, in some embodiments, the image analysis module 204 may examine multiple frames of a video to create a depth map and/or otherwise determine volume. Further, the image analysis module 204 may use color variation and other visual cues to determine the remaining quantity. In some embodiments, the mobile computing device 102 may access a remote server via the network 104 to retrieve information that may be used in estimating the quantity of ingredient 704 remaining (e.g., density of a particular ingredient).

Referring back to FIG. 5, in block 508, the mobile computing device 102 may save the determined type and quantity of the ingredient as ingredient data 120 in the data storage 118 of the mobile computing device 102. As discussed in detail below, the ingredient data 120 may be used by the meal planning module 210 to generate a meal schedule and/or track the shelf life of the available ingredients. In block 510, the mobile computing device 102 determines whether another ingredient is to be identified. If so, the method 500 returns to block 502 in which the next available ingredient is determined. Although the method 500 shows the mobile computing device 102 identifying a single ingredient at a time, the present concept is not so limited. Rather, in some embodiments, as discussed above, the mobile computing device 102 may determine the type and/or quantity of more than one ingredient concurrently. Further, in some embodiments, the camera 124 may be used to determine as much information about the type and quantity of the available ingredients as possible via the image analysis module 204, and the user may input the remaining information using audio or text input as discussed above. For example, the mobile computing device 102 may accurately identify the type of ingredient but prompt the user for the remaining quantity of the ingredient. In other embodiments, the mobile computing device 102 may use information from a previous recipe recommendation to estimate the remaining quantity of the ingredients.

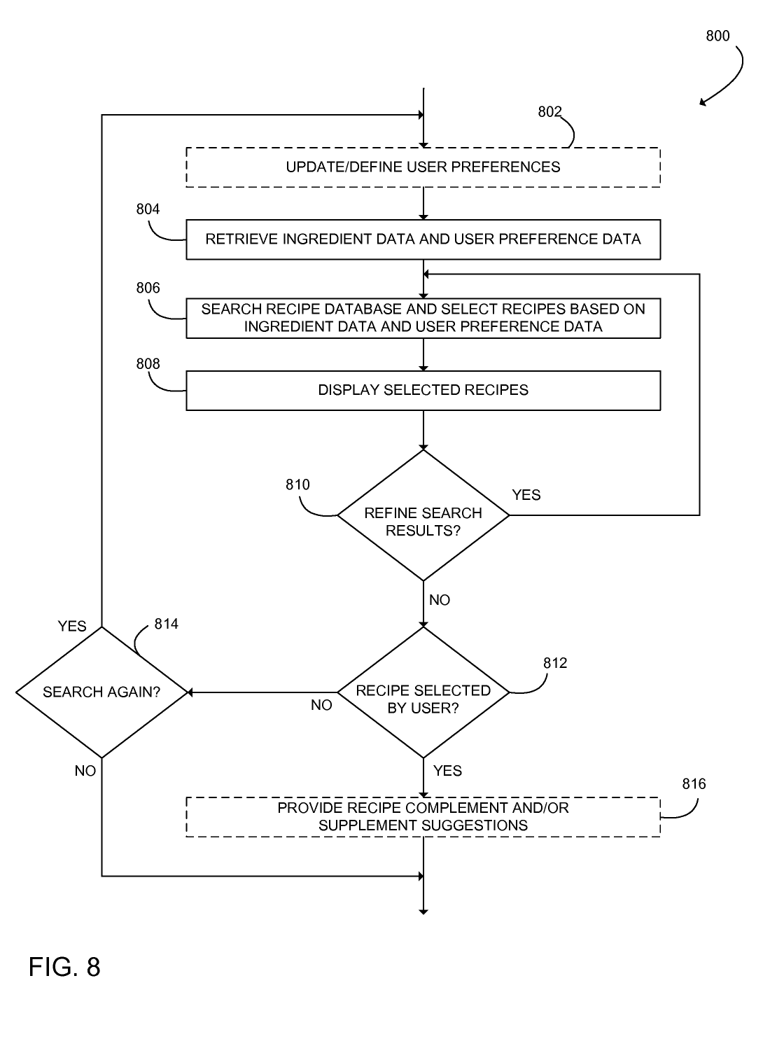

Referring back to FIG. 4, after the available ingredients have been determined in block 402, the method 400 advances to blocks 404 and 406. In block 404, the mobile computing device 102 determines whether the user has requested a recipe recommendation. If so, the mobile computing device 102 may generate recommended recipes in block 408. To do so, in some embodiments, the mobile computing device 102 may execute a method 800 as shown in FIG. 8. The method 800 begins with block 802 in which, the user may update or define their meal preferences. That is, in some embodiments, the user may store user preference data for later use and also implement one-time or temporary user preferences. For example, the user may indicate a taste or distaste for a particular ingredient and/or meal in block 802. The user preference data may also indicate the user's diet or allergies. For example, the user may be on a special diet such as a low fat and/or gluten free diet or the user may be allergic to peanuts. In another example, the user may have health issues such as diabetes or high cholesterol that should be taken into account in a recipe recommendation. In other embodiments, the user may want to override, refine, or otherwise define temporary preferences. For example, the user may have family visiting with young children, which are notoriously fastidious eaters, or people visiting from a number of other demographics. In other embodiments, the user may simply want to receive a recommendation with different preferences or restrictions for a change.

In block 804, the mobile computing device 102 retrieves the stored ingredient data 120 and user preference data, if any. In block 806, the mobile computing device 102 searches the recipe database 108 via the network 104 and selects recipes for the user based on the ingredient data 120 and the user preference data. As discussed above, the recipe database 108 may be embodied as more than one recipe database 108. For example, the recommendation engine 206 of the mobile computing device 102 may search recipes in several recipe databases 108 to provide appropriate recipe matches. In some embodiments, the mobile computing device 102 may search specialized recipe databases 108 depending on the context of the meal and/or the user preferences. In other embodiments, the mobile computing device 102 may search a global recipe database 108. In still other embodiments, the mobile computing device 102 may search various recipe-containing websites for appropriate recipes to recommend to the user.

In some embodiments, the mobile computing device 102 provides recommendations for recipes that may be made with the fewest number of additional ingredients. For example, if the ingredient data 120 indicates that the user has a cup of flour, two cans of tomato sauce, and eight ounces of mozzarella cheese, the mobile computing device 102 may search for recipes that require only those ingredients. Those recipes may be considered the best match. Recipes requiring one additional ingredient may be considered the next best, and so on. In other embodiments, the mobile computing device 102 may give the primary ingredients more weight than secondary ingredients and/or spices in providing recipe recommendations.

The number of recipes that could result from a search based on one or more ingredients alone, or even including user preferences, may be countless. As such, in selecting recipes to recommend, the mobile computing device 102 may consider the meal context as well. For example, the mobile computing device 102 may consider the time of day or the season when the user is requesting a recipe recommendation. That is, the mobile computing device 102 may be inclined to recommend breakfast dishes in the morning, dinner dishes during the evening, a romantic dinner for Valentine's Day, turkey for Thanksgiving Day, and/or turkey leftover recipes for one or more days following Thanksgiving. In the late evening, the mobile computing device 102 may recognize that the user is coming home late from work and suggest recipes that have a quick preparation time. In some embodiments, the user may enter the user's typical schedule into the mobile computing device 102, and any fluctuations out-of-the order or beyond some threshold may be appreciated by the mobile computing device 102 in suggesting recipes. In some embodiments, not only may the mobile computing device 102 consider the season in choosing season-appropriate dishes, but the mobile computing device 102 may give lower weight to grill-prepared meals during the winter months.

In other embodiments, the mobile computing device 102 may also consider the geographical location of the user. In doing so, the geographical location may be used in determining season-appropriate dishes as well as emphasize dishes preferred in the geographical region. For example, barbeque may be preferred in the southwest, and Cajun may be preferred in Louisiana. Additionally, in some embodiments, the mobile computing device 102 may consider the shelf life of the available ingredients. That is, the mobile computing device 102 may recommend recipes that use the perishable ingredients first. It should be appreciated that in some embodiments, the user may modify the user preferences to change the nature of the context aware search.

In block 808, the mobile computing device 102 displays the selected recipes for the user. In some embodiments, the mobile computing device 102 will display the recipe recommendation based on the ingredient(s) available on hand. In other embodiments, the default display of the recipe recommendations may differ. For example, the mobile computing device 102 may display the selected recipes sorted according to a percentage match with the ingredients on hand, the cuisine type (e.g., Italian, Chinese, Southwestern Barbeque, etc.), the preparation and/or cook time, the cooking method (e.g., grill, oven, slow cooker, pan stir fry), the shelf life of the ingredients, the most popular choice, or any number of other characteristics.

In block 810, the mobile computing device 102 determines whether the user desires to refine or otherwise modify the search results. If so, the method 800 loops back to block 806 in which the mobile computing device 102 provides new recipe recommendations based on the modified search. It should be appreciated that in some embodiments, the mobile computing device 102 may not provide a new search but simply rearrange or sort the current recommendations based on one or more criteria. If the user does not refine the search results, in block 812, the mobile computing device 102 determines whether the user has selected a recipe from the list of recipe recommendations. If not, the user may request recipe recommendations again in block 814. If the mobile computing device 102 determines that a new search is requested, the method 800 loops back to block 802 in which the user may update or define the user preferences. In some embodiments, the user may change the ingredients on which the search is based for the new search. If a recipe is not selected in block 812 and a new search is not requested in block 814, the method 800 may, for example, timeout, shutdown, idle, or prompt the user.

If a recipe has been selected by the user in block 812, the method 800 advances to block 816 in which the mobile computing device 102 may provide complementary recipes and/or suggestions to supplement the selected recipe. For example, the mobile computing device 102 may recommend wine pairing, desserts, side dishes, and/or other dishes that compliment the selected dish utilizing the same or other available ingredients. In some embodiments, the mobile computing device 102 may recommend that the user choose a new recipe if the same dish or a variation of the same dish has been prepared before, based on recipe history. Further, in some embodiments, the mobile computing device 102 may start a shopping list including any missing ingredients from the selected recipe. In other embodiments, the mobile computing device 102 may recommend nearby restaurants that prepare the chosen recipe or a similar recipe, cuisine, or theme. In some embodiments, the mobile computing device 102 may provide advertisements and coupons to local grocery stores and restaurants.

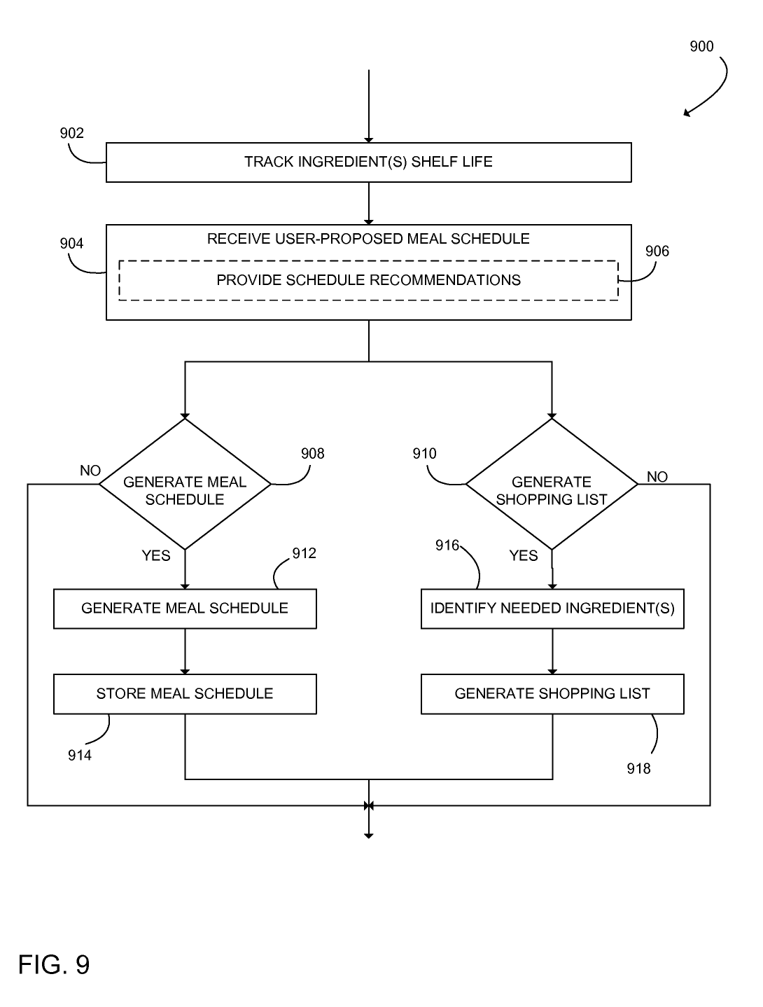

Referring back to FIG. 4, the mobile computing device 102 may also determine whether the user has selected the meal planner feature in block 406. If so, the mobile computing device 102 may generate a meal schedule in block 410. To do so, in some embodiments, the mobile computing device 102 may execute a method 900 as shown in FIG. 9. The method 900 begins with block 902 in which the mobile computing device 102 may track the shelf life of the available ingredients for the user. In some embodiments, the user may use the mobile computing device 102 to inventory any ingredients purchased during a shopping trip. Then, the mobile computing device 102 may track the shelf life of the ingredients. In doing so, the mobile computing device 102 may consider the purchase data of the ingredient and the open date of the ingredient. For example, some ingredients such a soy milk may last several months if unopened but only a couple weeks once opened. As such, in some embodiments, the mobile computing device 102 may use both dates to more accurately estimate a spoilage date.

In block 904, the mobile computing device 102 may receive a meal schedule proposed by the user. That is, the user may select multiple recipes from a list of recipe recommendations and place those recipes on days she/he plan to make the meal. In some embodiments, the recipes may be displayed in a calendar format or other user-friendly format. In block 906, the mobile computing device 102 may provide recommendations to the user regarding the schedule. For example, the mobile computing device 102 may suggest that the user rearrange certain scheduled meals to maximize the effective shelf life of one or more ingredients. In some embodiments, the mobile computing device 102 may suggest that the user store certain ingredients (e.g., flour) to increase the percentage of ingredients available for a number of meals.

After the user-proposed meal schedule is received in block 904, the method 900 advances to blocks 908 and 910. In block 908, the mobile computing device 102 determines whether the user desires to generate the meal schedule. If so, in block 912, the meal schedule is generated. The meal schedule may then be stored in the data storage 118 of the mobile computing device 102 in block 914. In some embodiments, the user may also print the generated meal schedule and/or the particular recipes on the meal schedule.

Referring back to block 910, the mobile computing device 102 determines whether to generate a shopping list for the user. In the illustrative embodiment of FIG. 9, if the mobile computing device 102 determines that the user has created a meal schedule with a recipe that includes at least one ingredient that is unavailable to the user, the mobile computing device 102 may automatically generate a shopping list. Alternatively, the user may prompt the mobile computing device 102 to generate the shopping list. Regardless, in block 916, the mobile computing device 102 may identify the missing or needed ingredients. In some embodiments, the mobile computing device 102 may add all of the missing ingredients from any of the recipes in the meal schedule. In other embodiments, the mobile computing device 102 may only add ingredients needed to prepare particular meals on the meal schedule. For example, the ingredients needed for one week's meals may be added. In other embodiments, the mobile computing device 102 may add all nonperishable ingredients to the shopping list but only add perishable ingredients up to a certain time/date on the schedule. The mobile computing device 102 may generate the shopping list for the user in block 918. The user may also print the shopping list, similar to the meal schedule.

### EXAMPLES

Illustrative examples of the devices, systems, and methods disclosed herein are provided below. An embodiment of the devices, systems, and methods may include any one or more, and any combination of, the examples described below.

Example 1 includes a mobile computing device for generating a list of recipe recommendations. The mobile computing device includes a peripheral input device to capture input of (i) a type of ingredient currently available to a user of the mobile computing device and (ii) a quantity of the currently available type of ingredient; a recommendation engine to (i) determine the type of the ingredient and the quantity of the ingredient as a function of the captured inputs, (ii) retrieve meal preference data indicating meal preferences of the user, and (iii) generate the list of recipe recommendations as a function of the inputted ingredient, the inputted ingredient quantity, and the meal preference data; and a display to display the list of recipe recommendations.

Example 2 includes the subject matter of Example 1, and wherein the peripheral input device is to capture an image of at least a portion of the ingredient.

Example 3 includes the subject matter of any of Example 1 and 2, and wherein the recommendation engine is to determine the type of the ingredient and the quantity of the ingredient by performing text recognition analysis on a product label in the image of the portion of the ingredient.

Example 4 includes the subject matter of any of Examples 1-3, and wherein the recommendation engine is to determine the type of the ingredient by performing object recognition analysis on the image of the portion of the ingredient.

Example 5 includes the subject matter of any of Examples 1-4, and wherein the recommendation engine is to determine the type of the ingredient and the quantity of the ingredient by analyzing a bar code on a product label in the image of the portion of the ingredient.

Example 6 includes the subject matter of any of Examples 1-5, and wherein (i) the peripheral device is to capturing audio data from the user of the mobile computing device and (ii) the recommendation engine is to determine the type of the ingredient and the quantity of the ingredient by analyzing the audio data using a voice recognition process.

Example 7 includes the subject matter of any of Examples 1-6, and wherein the peripheral device is to capture an image of at least a portion of the ingredient and (ii) the recommendation engine is to determine the quantity of the ingredient by performing text recognition on a product label in the image of the portion of the ingredient.

Example 8 includes the subject matter of any of Examples 1-7, and wherein (i) the peripheral device is to capture an image of at least a portion of the ingredient and (ii) the recommendation engine is to determine the quantity of the ingredient remaining in an opened package of the ingredient by using visual cues to analyze the image.

Example 9 includes the subject matter of any of Examples 1-8, and wherein the meal preference data indicates one or more of the user's diet, the user's allergies, and the user's food preferences.

Example 10 includes the subject matter of any of Examples 1-9, and wherein the recommendation engine is to generate the list of recipe recommendations by searching a recipe database; and selecting recipes as a function of the determined type of ingredient, the determined ingredient quantity, and the meal preference data.

Example 11 includes the subject matter of any of Examples 1-10, and wherein the recommendation engine is to generate the list of recipe recommendations by searching a recipe database; and selecting recipes as a function of the type and quantity of the ingredient currently available and a type and quantity of ingredients required to make the recipes.

Example 12 includes the subject matter of any of Examples 1-11, and wherein the display is to display the list of recipe recommendations ranked according to a ratio of ingredients available to ingredients required to make the recipes.

Example 13 includes the subject matter of any of Examples 1-12, and wherein the display is to display the list of recipe recommendations ranked according to a shelf life of ingredients available.

Example 14 includes the subject matter of any of Examples 1-13, and wherein the recommendation engine is to determine a selection by the user of a recipe from the list of recipe recommendations; and generate a recommendation for a complementary recipe as a function of the recipe selection.

Example 15 includes the subject matter of any of Examples 1-14, and wherein the recommendation engine is to determine a selection by the user of a recipe from the list of recipe recommendations, wherein the selected recipe requires one or more ingredients not currently available to the user; and generating a shopping list including the one or more ingredients.

Example 16 includes the subject matter of any of Examples 1-15, and wherein the recommendation is to store the type of the ingredient and the quantity of the ingredient on a memory of the mobile computing device.

Example 17 includes the subject matter of any of Examples 1-18, and further includes a meal planning module to determine a meal schedule generated by the user; and generate recommended changes to the meal schedule.

Example 18 includes the subject matter of any of Examples 1-17, and wherein the meal planning module is to generate recommended changes as a function of a shelf life of currently available ingredients.

Example 19 includes the subject matter of any of Examples 1-18, and wherein the recommendation engine is to generate the list of recipe recommendations further as a function of a meal context.

Example 20 includes a smart storage for generating a list of recipe recommendations. The smart storage includes one or more sensors to generate sensor data as a function of available ingredients stored in the smart storage; a recommendation engine to (i) determine a type of an ingredient of the available ingredients and a quantity of the ingredient as a function of the sensor data, (ii) retrieve meal preference data indicating meal preferences of a user of the smart storage, and (iii) generate the list of recipe recommendations as a function of the determined ingredient type, the determined ingredient quantity, and the meal preference data.

Example 21 includes the subject matter of Example 20, and wherein the one or more sensors includes a camera to capture an image of at least a portion of the ingredient.

Example 22 includes the subject matter of any of Examples 20 and 21, and wherein the recommendation engine is to generate the list of recipe recommendations by searching a recipe database; and selecting recipes as a function of the type and the quantity of the available ingredient and a type and quantity of ingredients required to make the recipes.

Example 23 includes the subject matter of any of Examples 20-22, and wherein the recommendation engine is to generate the list of recipe recommendations further as a function of a meal context.

Example 24 includes the subject matter of any of Examples 20-23, and further includes a communication module to transmit the list of recipe recommendations to a mobile computing device.

Example 25 includes the subject matter of any of Examples 20-24, and wherein the smart storage is one of a smart refrigerator and a smart pantry.

Example 26 includes a method for generating a list of recipe recommendations on a mobile computing device. The method includes determining, using the mobile computing device, a type of ingredient currently available to a user of the mobile computing device; determining, with the mobile computing device, a quantity of the currently available type of ingredient; retrieving, with the mobile computing device, meal preference data indicating meal preferences of the user generating, using the mobile computing device, the list of recipe recommendations as a function of the determined type of ingredient, the determined ingredient quantity, and the meal preference data; and displaying, on the mobile computing device, the list of recipe recommendations.

Example 27 includes the subject matter of Example 26, and wherein determining the type of ingredient comprises capturing an image of at least a portion of the ingredient; and analyzing the captured image to identify the type of the ingredient.

Example 28 includes the subject matter of any of Examples 26 and 27, and wherein analyzing the captured image comprises performing text recognition on a product label of the ingredient.

Example 29 includes the subject matter of any of Examples 26-28, and wherein analyzing the captured image comprises performing object recognition analysis of the ingredient.

Example 30 includes the subject matter of any of Examples 26-29, and wherein analyzing the captured image comprises analyzing a bar code on a product label of the ingredient.

Example 31 includes the subject matter of any of Examples 26-29, and wherein determining the type of ingredient comprises capturing audio data from the user of the mobile computing device; and analyzing the audio data using a voice recognition process.

Example 32 includes the subject matter of any of Examples 26-31, and wherein determining the quantity of the currently available ingredient comprises capturing an image of at least a portion of the ingredient; and performing text recognition on a product label of the ingredient.

Example 33 includes the subject matter of any of Examples 26-32, and wherein determining the quantity of the currently available ingredient comprises capturing an image of at least a portion of the ingredient; and using visual cues to determine the quantity of the ingredient remaining in an opened package of the ingredient.

Example 34 includes the subject matter of any of Examples 26-33 and wherein retrieving meal preference data comprises retrieving meal preference data indicating one or more of the user's diet, the user's allergies, and the user's food preferences.

Example 35 includes the subject matter of any of Examples 26-34 and wherein generating the list of recipe recommendations comprises searching a recipe database; and selecting recipes as a function of the determined type of ingredient, the determined ingredient quantity, and the meal preference data.

Example 36 includes the subject matter of any of Examples 26-35, and wherein generating the list of recipe recommendations comprises searching a recipe database; and selecting recipes as a function of the type and quantity of the ingredient currently available and a type and quantity of ingredients required to make the recipes.

Example 37 includes the subject matter of any of Examples 26-36, and wherein displaying the list of recipe recommendations comprises displaying the list ranked according to a ratio of ingredients available to ingredients required to make the recipes.

Example 38 includes the subject matter of any of Examples 26-37, and wherein displaying the list of recipe recommendations comprises displaying the list ranked according to a shelf life of ingredients available.

Example 39 includes the subject matter of any of Examples 26-38, and further includes determining, with the mobile computing device, a selection by the user of a recipe from the list of recipe recommendations; and generating, using the mobile computing device, a recommendation for a complementary recipe as a function of the recipe selection.

Example 40 includes the subject matter of any of Examples 26-39, and further includes determining, with the mobile computing device, a selection by the user of a recipe from the list of recipe recommendations, wherein the selected recipe requires one or more ingredients not currently available to the user; and generating, using the mobile computing device, a shopping list including the one or more ingredients.

Example 41 includes the subject matter of any of Examples 26-40, and further includes storing, on the mobile computing device, the type of the ingredient and the quantity of the ingredient.

Example 42 includes the subject matter of any of Examples 26-41, and further includes determining, on the mobile computing device, a meal schedule generated by the user; generating, using the mobile computing device, recommended changes to the meal schedule.

Example 43 includes the subject matter of any of Examples 26-42, and wherein generating recommended changes comprises generating recommended changes as a function of a shelf life of currently available ingredients.

Example 44 includes the subject matter of any of Examples 26-43, and wherein generating the list of recipe recommendations is further a function of a meal context.

Example 45 includes a method for generating a list of recipe recommendations with a smart storage. The method include generating sensor data, using one or more sensors of the smart storage, as a function of available ingredients stored in the smart storage; determining, using the smart storage, a type of an ingredient of the available ingredients and a quantity of the ingredient as a function of the sensor data; retrieving, with the smart storage, meal preference data indicating meal preferences of a user of the smart storage; and generating, using the smart storage, the list of recipe recommendations as a function of the determined ingredient type, the determined ingredient quantity, and the meal preference data.

Example 46 includes the subject matter of Example 45, and wherein generating sensor data comprises capturing an image of at least a portion of the ingredient.

Example 47 includes the subject matter of any of Examples 45 and 46, and wherein generating the list of recipe recommendations comprises: searching a recipe database; and selecting recipes as a function of the type and the quantity of the ingredient currently available and a type and quantity of ingredients required to make the recipes.

Example 48 includes the subject matter of any of Examples 45-47, and wherein generating the list of recipe recommendations is further a function of a meal context.

Example 49 includes the subject matter of any of Examples 45-48, and further includes transmitting the list of recipe recommendations to a mobile computing device.

Example 50 includes a computing device having a processor and a memory having stored therein a plurality of instructions that when executed by the processor cause the computing device to perform the method of any of Examples 26-49.

Example 52 includes one or more machine readable storage media comprising a plurality of instructions stored thereon that in response to being executed result in a computing device performing the method of any of Examples 26-49.

1. A mobile computing device for generating a list of recipe recommendations, the mobile computing device comprising:
a peripheral input device to capture input of (i) a type of ingredient currently available to a user of the mobile computing device and (ii) a quantity of the currently available type of ingredient;
a recommendation engine to (i) determine the type of the ingredient and the quantity of the ingredient as a function of the captured inputs, (ii) retrieve meal preference data indicating meal preferences of the user, and (iii) generate the list of recipe recommendations as a function of the inputted ingredient, the inputted ingredient quantity, and the meal preference data; and
a display to display the list of recipe recommendations.

2. The mobile computing device of claim 1, wherein:
the peripheral input device is to capture an image of at least a portion of the ingredient; and
the recommendation engine is to determine the type of the ingredient and the quantity of the ingredient by performing one or more of text recognition analysis and bar code analysis of a product label in the image of the portion of the ingredient.

3. The mobile computing device of claim 1, wherein:
the peripheral input device is to capture an image of at least a portion of the ingredient; and
the recommendation engine is to determine the type of the ingredient by performing object recognition analysis on the image of the portion of the ingredient.

4. The mobile computing device of claim 1, wherein (i) the peripheral device is to capturing audio data from the user of the mobile computing device and (ii) the recommendation engine is to determine the type of the ingredient and the quantity of the ingredient by analyzing the audio data using a voice recognition process.

5. The mobile computing device of claim 1, wherein:
the peripheral device is to capture an image of at least a portion of the ingredient; and
the recommendation engine is to determine the quantity of the ingredient by performing one or more of (i) text recognition analysis on a product label in the image of the portion of the ingredient and, (ii) if the ingredient has an opened package, visual cue analysis on the image of the portion of the ingredient.

6. The mobile computing device of claim 1, wherein the meal preference data indicates one or more of the user's diet, the user's allergies, and the user's food preferences.

7. The mobile computing device of claim 1, wherein the recommendation engine is to generate the list of recipe recommendations by:
searching a recipe database; and
selecting recipes as a function of the determined type of ingredient, the determined ingredient quantity, and the meal preference data.

8. The mobile computing device of claim 1, wherein the display is to display the list of recipe recommendations ranked according to at least one of: a ratio of ingredients available to ingredients required to make the recipes and a shelf life of ingredients available.

9. The mobile computing device of claim 1, wherein the recommendation engine is to:
determine a selection by the user of a recipe from the list of recipe recommendations; and
generate one or more of (i) a recommendation for a complementary recipe as a function of the recipe selection and (ii) a shopping list including the one or more ingredients in response to the selected recipe requiring one or more ingredients not currently available to the user.

10. The mobile computing device of claim 1, further comprising a meal planning module to:
determine a meal schedule generated by the user; and
generate recommended changes to the meal schedule as a function of a shelf life of currently available ingredients.

11. The mobile computing device of claim 1, wherein the recommendation engine is to generate the list of recipe recommendations further as a function of a meal context.

12. A smart storage for generating a list of recipe recommendations, the smart storage comprising:
one or more sensors to generate sensor data as a function of available ingredients stored in the smart storage;
a recommendation engine to (i) determine a type of an ingredient of the available ingredients and a quantity of the ingredient as a function of the sensor data, (ii) retrieve meal preference data indicating meal preferences of a user of the smart storage, and (iii) generate the list of recipe recommendations as a function of the determined ingredient type, the determined ingredient quantity, and the meal preference data.

13. The smart storage of claim 12, wherein the one or more sensors includes a camera to capture an image of at least a portion of the ingredient.

14. The smart storage of claim 12, wherein the recommendation engine is to generate the list of recipe recommendations by:
searching a recipe database; and
selecting recipes as a function of the type and the quantity of the available ingredient and a type and quantity of ingredients required to make the recipes.

15. The smart storage of claim 12, further comprising a communication module to transmit the list of recipe recommendations to a mobile computing device.

16. The smart storage of claim 12, wherein the smart storage is one of a smart refrigerator and a smart pantry.

17. One or more machine-readable storage media comprising a plurality of instructions stored thereon, that in response to being executed, result in a mobile computing device:
determining a type of ingredient currently available to a user of the mobile computing device;
determining a quantity of the currently available type of ingredient;
retrieving meal preference data indicating meal preferences of the user;
generating the list of recipe recommendations as a function of the determined type of ingredient, the determined ingredient quantity, and the meal preference data; and
displaying the list of recipe recommendations.

18. The one or more machine-readable storage media of claim 17, wherein determining the type of ingredient comprises:
capturing an image of at least a portion of the ingredient; and
analyzing the captured image to identify the type of the ingredient by performing at least one of: text recognition on a product label of the ingredient, object recognition analysis of the ingredient, and bar code analysis of the product label.

19. The one or more machine-readable storage media of claim 17, wherein determining the type of ingredient comprises:
capturing audio data from the user of the mobile computing device; and
analyzing the audio data using a voice recognition process.

20. The one or more machine-readable storage media of claim 17, wherein determining the quantity of the currently available ingredient comprises:
capturing an image of at least a portion of the ingredient; and
performing one or more of (i) text recognition on a product label of the ingredient and, (ii) if the ingredient has an opened package, visual cue analysis of the ingredient.

21. The one or more machine-readable storage media of claim 17, wherein retrieving meal preference data comprises retrieving meal preference data indicating one or more of the user's diet, the user's allergies, and the user's food preferences.

22. The one or more machine-readable storage media of claim 26, wherein generating the list of recipe recommendations comprises:
searching a recipe database; and
selecting recipes as a function of the determined type of ingredient, the determined ingredient quantity, and the meal preference data.

23. The one or more machine-readable storage media of claim 17, wherein displaying the list of recipe recommendations comprises displaying the list ranked according to one or more of a ratio of ingredients available to ingredients required to make the recipes and a shelf life of ingredients available.

24. The one or more machine-readable storage media of claim 17, wherein the plurality of instructions further result in the computing device:
determining a selection by the user of a recipe from the list of recipe recommendations; and
generating one or more of (i) a recommendation for a complementary recipe as a function of the recipe selection and (ii) a shopping list including the one or more ingredients in response to the selected recipe requiring one or more ingredients not currently available to the user.

25. The one or more machine-readable storage media of claim 17, further comprising:
determining a meal schedule generated by the user;
generating recommended changes to the meal schedule as a function of a shelf life of currently available ingredients.

26. The one or more machine-readable storage media of claim 17, wherein generating the list of recipe recommendations is further a function of a meal context.
